(19) United States
(12) Patent Application Publication
(10) Pub. No.: US 2006/0082608 A1
(43) Pub. Date: Apr. 20, 2006

(54) Ink jet apparatus

(75) Inventors: Sharon S. Berger, Canby, OR (US); Andrey S. Kim, Woodburn, OR (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/296,142

(22) Filed: Dec. 7, 2005

Related U.S. Application Data
(62) Division of application No. 10/897,527, filed on Jul. 22, 2004.
Application No. 10/897,527 is a continuation of application No. 10/283,888, filed on Oct. 30, 2002, now abandoned.

(51) Int. Cl. B41J 29/38

(52) U.S. Cl. 347/10

(57) ABSTRACT

A drop emitting device that includes a drop generator, a drive signal including a plurality of fire intervals applied to the drop generator, wherein the drive signal includes in each fire interval a bi-polar drop firing waveform or a time varying non-firing waveform.

This is a divisional of U.S. Continuation application Ser. No. 10/897,527, filed Jul. 22, 2004, which is a continuation of U.S. application Ser. No. 10/283,888, filed Oct. 30, 2002, now abandoned.

### BACKGROUND OF THE DISCLOSURE

Drop on demand ink jet technology for producing printed media has been employed in commercial products such as printers, plotters, and facsimile machines. Generally, an ink jet image is formed by selective placement on a receiver surface of ink drops emitted by a plurality of drop generators implemented in a printhead or a printhead assembly. For example, the printhead assembly and the receiver surface are caused to move relative to each other, and drop generators are controlled to emit drops at appropriate times, for example by an appropriate controller. The receiver surface can be a transfer surface or a print medium such as paper. In the case of a transfer surface, the image printed thereon is subsequently transferred to an output print medium such as paper.

A known ink jet drop generator structure employs an electromechanical transducer to displace ink from an ink chamber into a drop forming outlet passage, and it can be difficult to control drop velocity and/or drop mass.

### BRIEF DESCRIPTION OF DRAWINGS

FIG. 1 is a schematic block diagram of an embodiment of a drop-on-demand drop emitting apparatus.

FIG. 2 is a schematic block diagram of an embodiment of a drop generator that can be employed in the drop emitting apparatus of FIG. 1.

FIG. 3 is a schematic depiction of an embodiment of a drive signal that can be employed to drive the drop generator of FIG. 2.

FIG. 4 is a schematic depiction of another embodiment of a drive signal that can be employed to drive the drop generator of FIG. 2.

FIG. 5 is a schematic depiction of a further embodiment of a drive signal that can be employed to drive the drop generator of FIG. 2.

### DETAILED DESCRIPTION OF THE DISCLOSURE

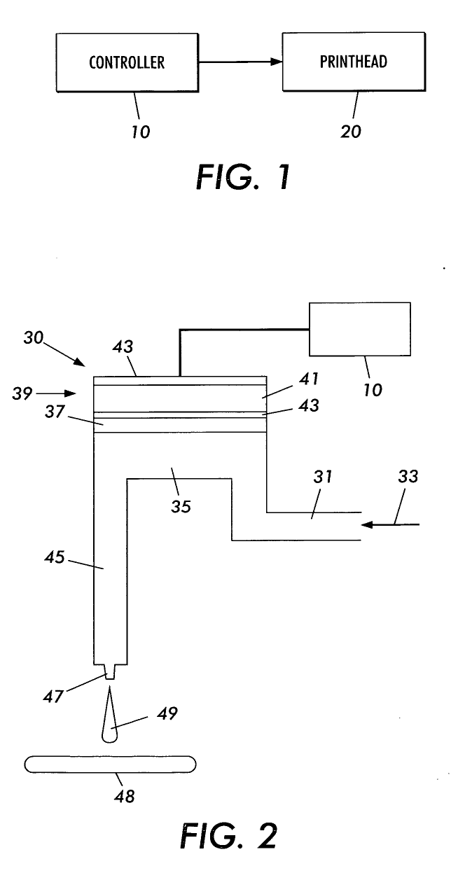

FIG. 1 is schematic block diagram of an embodiment of a drop-on-demand printing apparatus that includes a controller 10 and a printhead assembly 20 that can include a plurality of drop emitting drop generators. The controller 10 selectively energizes the drop generators by providing a respective drive signal to each drop generator. Each of the drop generators can employ a piezoelectric transducer. As other examples, each of the drop generators can employ a shear-mode transducer, an annular constrictive transducer, an electrostrictive transducer, an electromagnetic transducer, or a magnetorestrictive transducer. The printhead assembly 20 can be formed of a stack of laminated sheets or plates, such as of stainless steel.

FIG. 2 is a schematic block diagram of an embodiment of a drop generator 30 that can be employed in the printhead assembly 20 of the printing apparatus shown in FIG. 1. The drop generator 30 includes an inlet channel 31 that receives ink 33 from a manifold, reservoir or other ink containing structure. The ink 33 flows into a pressure or pump chamber 35 that is bounded on one side, for example, by a flexible diaphragm 37. An electromechanical transducer 39 is attached to the flexible diaphragm 37 and can overlie the pressure chamber 35, for example. The electromechanical transducer 39 can be a piezoelectric transducer that includes a piezo element 41 disposed for example between electrodes 43 that receive drop firing and non-firing signals from the controller 10. Actuation of the electromechanical transducer 39 causes ink to flow from the pressure chamber 35 to a drop forming outlet channel 45, from which an ink drop 49 is emitted toward a receiver medium 48 that can be a transfer surface, for example. The outlet channel 45 can include a nozzle or orifice 47.

The ink 33 can be melted or phase changed solid ink, and the electromechanical transducer 39 can be a piezoelectric transducer that is operated in a bending mode, for example.

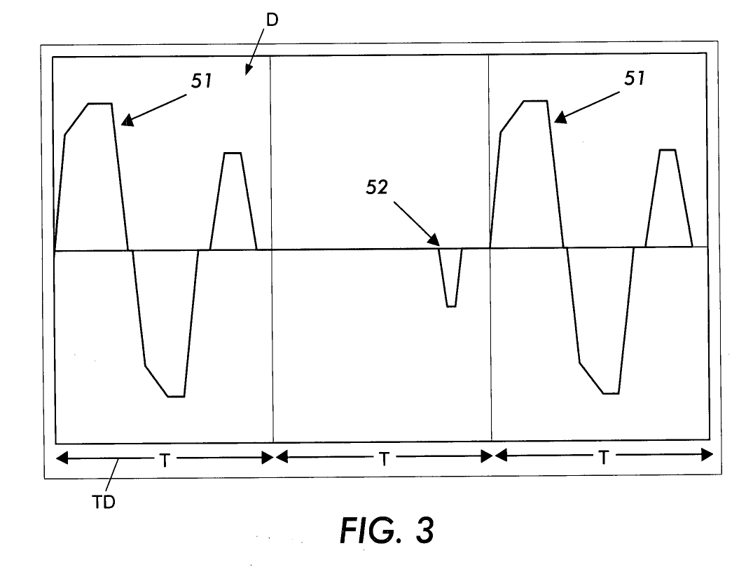

FIG. 3 is a schematic diagram of an example of a drive signal D for energizing the drop generator of FIG. 2. The drive signal D includes a plurality of sequential fire intervals TD of time duration T, and within each fire interval TD the drive signal D includes either a time varying drop firing signal or waveform 51, or a time varying non-firing signal or waveform 52. The time varying drop firing waveform 51 is shaped or configured to actuate the electromechanical transducer such that the drop generator emits an ink drop, while the non-firing waveform 52 is shaped or configured to perturb the electromechanical transducer without causing a drop to the emitted. By way of illustrative example, the firing interval duration T can be in the range of about 56 microseconds to about 28 microseconds, such that the drop generator can be operated in the range of about 18 KHz to about 36 KHz. As another example, the firing interval duration T can be in the range of about 1000 microseconds to about 28 microseconds, such that the drop generator can be operated in a range of about 1 KHz to about 36 KHz.

The time varying non-firing waveform can be configured to set the condition of the drop generator 30 for the next fire interval.

For example, the time varying non-firing waveform 52 can be shaped or configured to place the drop generator 30 in a fluid dynamics condition similar to the fluid dynamics condition the drop generator 30 would be in after firing a drop. In this manner, the drop generator 30 is placed in substantially the same fluid dynamics condition each time the drop generator fires, which can provide for more consistent drop velocity and/or drop mass over a broad range of operating conditions.

As another example, the time varying non-firing waveform 52 can be shaped or configured such that the spectral energy of the drive signal is approximately the same for different firing patterns. In other words, the spectral energy of the drive signal is approximately the same regardless of whether a sequence of fire intervals includes only drop firing waveforms or includes drop firing waveforms and non-firing waveforms.

Alternatively, the time varying non-firing waveform can be shaped or configured so that it does affect the spectral energy of the drive signal, which can affect the condition of the drop generator. That is, the spectral energy of the drive can vary with firing pattern.

In a further example, the time varying non-firing waveform 52 can be shaped or configured to reduce variation in drop velocity such that drop velocity is approximately constant regardless of whether a given drop firing waveform follows a drop firing waveform or a non-firing waveform. In other words, the drop velocity is not substantially affected by the firing pattern.

Also, the time varying non-firing waveform 52 can be shaped or configured to reduce variation in drop mass such that drop mass is approximately constant regardless of whether a given drop firing waveform follows a drop firing waveform or a non-firing waveform. In other words, drop mass is not substantially affected by the firing pattern.

The time varying non-firing waveform 52 can further be shaped or configured to change a drop parameter when a given drop firing waveform follows a non-firing waveform.

By way of illustrative example, as depicted in FIG. 3, the time varying drop firing waveform 41 can be a bi-polar voltage signal having a component that is greater than 0 volts and a component that is less than 0 volts. Alternatively, the time varying drop firing waveform can be a signal that includes a pulse component that is greater than a reference and a pulse component that is less than the reference.

The time varying non-firing waveform can be a unipolar voltage signal such as a pulse that can be positive or negative, for example relative to a reference. A non-firing pulse can have a pulse duration that is less than a fire interval, for example, wherein pulse duration can be measured for convenience between pulse transition times (i.e., the transition from the reference and the transition to the reference. A non-firing pulse can be located anywhere in a fire interval. For example, a non-firing pulse can be approximately centered in a fire interval or it can be located only in either the first half or the second half of a fire interval. By way of specific example, the time varying non-firing waveform can be a negative going pulse having a width that is in the range of about 10% to about 90% of the firing interval T (i.e., about 0.1 T to about 0.9 T).

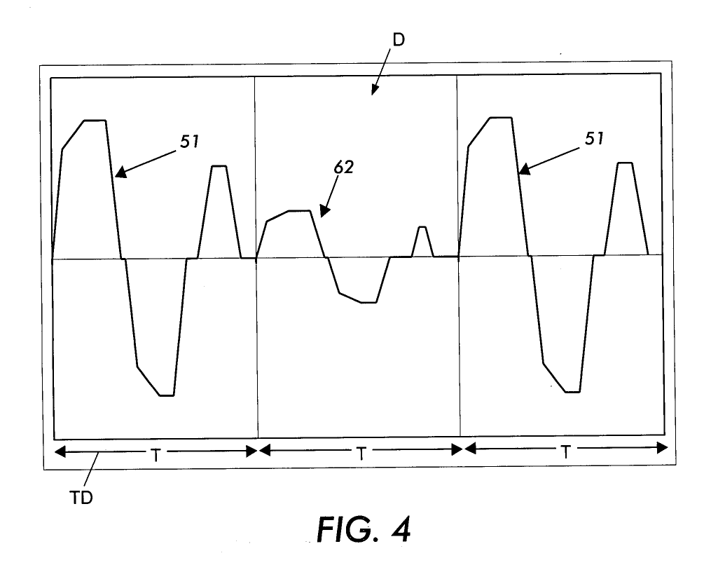

As another example, illustrated in FIG. 4, a time varying non-firing waveform 62 can be a reduced voltage or amplitude version of the firing waveform 51.

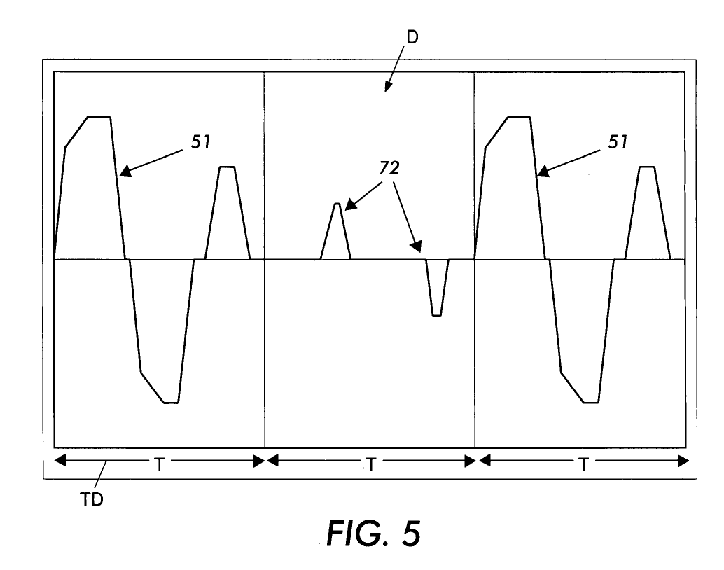

As a further example illustrated in FIG. 5, a time varying non-firing waveform 72 can comprise two pulses, one positive pulse in the first half of a firing interval and a negative pulse in the second half of the firing interval. The width of each pulse can be in the range of about 10% to about 50% of the firing interval duration T.

The invention has been described with reference to disclosed embodiments, and it will be appreciated that variations and modifications can be affected within the spirit and scope of the invention.

What is claimed is:

1. A drop emitting device comprising:
a drop generator;
a drive signal including a series of separate, contiguously adjacent, non-overlapping fire intervals applied to the drop generator, each fire interval having a duration T;
the drive signal including a plurality of non-firing bi-polar waveforms and a plurality of drop firing bi-polar waveforms in separate, respective fire intervals;
wherein each of the non-firing bi-polar waveforms and the drop firing bi-polar waveforms is in a separate, respective fire interval;
wherein each fire interval includes either a non-firing bi-polar waveform or a drop firing bi-polar waveform, and not both; and
wherein a fire interval that includes a non-firing bi-polar waveform does not cause a drop to be fired.

2. The drop emitting device of claim 1 wherein each non-firing bi-polar waveform is approximately centered in the fire interval in which it is present.

3. The drop emitting device of claim 1 wherein each non-firing bi-polar waveform comprises a pulse of a first polarity and a pulse of a second polarity, wherein the second polarity is different from the first polarity.

4. The drop emitting device of claim 1:
wherein each non-firing bi-polar waveform comprises a pulse of a first polarity and a pulse of a second polarity, wherein the second polarity is different from the first polarity; and
wherein the pulse of the first polarity is located in a first half of the fire interval in which it is present, and wherein the pulse of the second polarity is located in a second half of such fire interval.

5. The drop emitting device of claim 1 wherein the non-firing bi-polar waveforms comprise reduced amplitude versions of the drop firing bi-polar waveforms.

6. A drop emitting device comprising:
a drop generator;
a drive signal including a first fire interval, a second fire interval, and a third fire interval applied to the drop generator, the first through third fire intervals being separate, contiguously adjacent, non-overlapping and in sequence starting with the first fire interval, and each of the first through third fire intervals having a duration T;
the firs t fire interval including one and only one non-firing unipolar pulse, the second fire interval including one and only one non-firing unipolar pulse, and the third fire interval including a drop firing bi-polar waveform;
wherein the first fire interval, which includes one and only one non-firing unipolar pulse, does not cause a drop to be fired; and
wherein the second fire interval, which includes one and only one non-firing unipolar pulse, does not cause a drop to be fired;
whereby the first fire interval and the second fire interval comprise contiguously adjacent fire intervals that each include one and only one non-firing unipolar pulse.

7. The drop emitting device of claim 6 wherein each non-firing unipolar pulse is a negative going pulse that is located only in a first half of the fire interval in which such non-firing unipolar pulse is present.

8. The drop emitting device of claim 6 wherein each non-firing unipolar pulse is a negative going pulse that is located only in a second half of the fire interval in which such non-firing unipolar pulse is present.

9. The drop emitting device of claim 6 wherein each non-firing unipolar pulse is a negative going pulse that is approximately centered in the fire interval in which such non-firing unipolar pulse is present.

10. The drop emitting device of claim 6 wherein each non-firing unipolar pulse is a positive going pulse that is located only in a first half of the fire interval in which such non-firing unipolar pulse is present.

11. The drop emitting device of claim 6 wherein each non-firing unipolar pulse is a positive going pulse that is located only in a second half of the fire interval in which such non-firing unipolar pulse is located.

12. The drop emitting device of claim 6 wherein each non-firing unipolar pulse is a positive going pulse that is approximately centered in the fire interval in which such non-firing unipolar pulse is present.

13. A drop emitting device comprising:
a drop generator;
a drive signal including a first fire interval, a second fire interval, and a third fire interval applied to the drop generator, the first through third fire intervals being separate, contiguously adjacent, non-overlapping and in sequence starting with the first fire interval, and each of the first through third fire intervals having a duration T;
the first fire interval including a drop firing bi-polar waveform the second fire interval including one and only one non-firing unipolar pulse, and the third fire interval including one and only one non-firing unipolar pulse;
wherein the second fire interval, which includes one and only one non-firing unipolar pulse, does not cause a drop to be fired; and
wherein the third fire interval, which includes one and only one non-firing unipolar pulse, does not cause a drop to be fired;
whereby the second fire interval and the third fire interval comprise contiguously adjacent fire intervals that each include one and only one non-firing unipolar pulse.

14. The drop emitting device of claim 13 wherein each non-firing unipolar pulse is a negative going pulse that is located only in a first half of the fire interval in which such non-firing unipolar pulse is present.

15. The drop emitting device of claim 13 wherein each non-firing unipolar pulse is a negative going pulse that is located only in a second half of the fire interval in which such non-firing unipolar pulse is present.

16. The drop emitting device of claim 13 wherein each non-firing unipolar pulse is a negative going pulse that is approximately centered in the fire interval in which such non-firing unipolar pulse is present.

17. The drop emitting device of claim 13 wherein each non-firing unipolar pulse is a positive going pulse that is located only in a first half of the fire interval in which such non-firing unipolar pulse is present.

18. The drop emitting device of claim 13 wherein each non-firing unipolar pulse is a positive going pulse that is located only in a second half of the fire interval in which such non-firing unipolar pulse is located.

19. The drop emitting device of claim 13 wherein each non-firing unipolar pulse is a positive going pulse that is approximately centered in the fire interval in which such non-firing unipolar pulse is present.
